(19) United States
(12) Patent Application Publication
(10) Pub. No.: US 2025/0392427 A1
(43) Pub. Date: Dec. 25, 2025

(54) METHOD OF SRS RESOURCE ALLOCATION AND USER EQUIPMENT

(71) Applicant: GUANGDONG OPPO MOBILE TELECOMMUNICATIONS CORP., LTD., Dongguan (CN)

(72) Inventor: Li GUO, Allen, TX (US)

(21) Appl. No.: 19/317,380

(22) Filed: Sep. 3, 2025

Related U.S. Application Data
(63) Continuation of application No. PCT/CN2024/080545, filed on Mar. 7, 2024.
(60) Provisional application No. 63/456,381, filed on Mar. 31, 2023.

(51) Int. Cl. H04L 5/00; H04W 56/00

(52) U.S. Cl. CPC H04L 5/005; H04W 56/0045

(57) ABSTRACT

A method of sounding reference signal (SRS) resource allocation, by a user equipment (UE) includes being configured by a base station with a first uplink (UL) carrier and a second UL carrier and being indicated by the base station that a first SRS resource in the first UL carrier and a second SRS resource in the second UL carrier are aggregated with bandwidth.

### CROSS REFERENCE TO RELATED APPLICATION(S)

This application is a continuation of International Application No. PCT/CN2024/080545, filed Mar. 7, 2024, which claims priority to U.S. Provisional Application No. 63/456,381, filed Mar. 31, 2023, the disclosures of which are hereby incorporated by reference in their entireties.

### TECHNICAL FIELD

The present disclosure relates to the field of communication systems, and more particularly, to methods of sounding reference signal (SRS) resource allocation and a user equipment (UE).

### BACKGROUND

In current systems, sounding reference signal (SRS) used for positioning is transmitted within each uplink bandwidth part (BWP) of each uplink carrier. A bandwidth of an SRS for positioning is limited, even when a user equipment (UE) has enough power to transmit the SRS for positioning. Therefore, a performance of uplink timing-based positioning is limited. The UE can transmit multiple SRSs for positioning in multiple uplink carriers, but the current new radio (NR) system and 3rd generation partnership project (3GPP) speciation does enable the NR system to coherently combine SRS for positioning transmitted in different carriers to formulate an equivalent larger bandwidth.

Therefore, there is a need for apparatuses and methods of sounding reference signal (SRS) resource allocation.

### SUMMARY

In a first aspect of the present disclosure, a method of sounding reference signal (SRS) resource allocation, by a user equipment (UE), includes being configured by a base station with a first uplink (UL) carrier and a second UL carrier and being indicated by the base station that a first SRS resource in the first UL carrier and a second SRS resource in the second UL carrier are aggregated with bandwidth.

In a second aspect of the present disclosure, a method of sounding reference signal (SRS) resource allocation, by a base station, includes configuring, to a user equipment (UE), a first uplink (UL) carrier and a second UL carrier and indicating to the UE that a first SRS resource in the first UL carrier and a second SRS resource in the second UL carrier are aggregated with bandwidth.

In a third aspect of the present disclosure, a UE includes a memory, a transceiver, and a processor coupled to the memory and the transceiver. The UE is configured to perform the method in the first aspect.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a diagram illustrating an example of positioning based on downlink (DL) measurement.

FIG. 2 is a block diagram of one or more user equipments (UEs) and a base station of communication in a communication network system according to an embodiment of the present disclosure.

FIG. 3 is a block diagram of a UE according to an embodiment of the present disclosure.

FIG. 4 is a block diagram of a UE according to an embodiment of the present disclosure.

FIG. 5 is a flowchart illustrating a method of sounding reference signal (SRS) resource allocation performed by a UE according to an embodiment of the present disclosure.

FIG. 6 is a block diagram of a base station according to an embodiment of the present disclosure.

FIG. 7 is a block diagram of a base station according to an embodiment of the present disclosure.

FIG. 8 is a flowchart illustrating a method of sounding reference signal (SRS) resource allocation performed by a base station according to an embodiment of the present disclosure.

FIG. 9 is a block diagram of an example of a computing device according to an embodiment of the present disclosure.

FIG. 10 is a block diagram of a communication system according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

The technical solutions of the embodiments of the present disclosure can be applied to various communication systems, such as a global system of mobile communication (GSM) system, a code division multiple access (CDMA) system, a wideband code division multiple access (WCDMA) system, a general packet radio service (GPRS), a long term evolution (LTE) system, a LTE frequency division duplex (FDD) system, a LTE time division duplex (TDD) system, an advanced long term evolution (LTE-A) system, a new radio (NR) system, an evolution system of a NR system, a LTE-based access to unlicensed spectrum (LTE-U) system, a NR-based access to unlicensed spectrum (NR-U) system, an universal mobile telecommunication system (UMTS), a global interoperability for microwave access (WiMAX) communication system, wireless local area networks (WLAN), wireless fidelity (Wi-Fi), a future 5th generation (5G) system (may also be called a new radio (NR) system) or other communication systems, etc.

Optionally, a base station mentioned in the embodiments of the present application can provide a communication coverage for a specific geographic area and can communicate with a user equipment (UE) located in the coverage area. Optionally, the base station may be a gNB, a base transceiver station (BTS) in the GSM or in the CDMA system, or may be a NodeB (NB) in the WCDMA system, or may be an evolutional Node B (eNB or eNodeB) in the LTE system, or a radio controller in a cloud radio access network (CRAN).

A user equipment (UE) may refer to an access terminal, a subscriber unit, a subscriber station, a mobile station, a remote station, a remote terminal, a mobile device, a user terminal, a terminal, a wireless communication device, a user agent, or a user device. The access terminal may be a cellular radio telephone, a cordless telephone, a session initiation protocol (SIP) telephone, a wireless local loop (WLL) station, a personal digital assistant (PDA), a handheld device with wireless communication functions, a computing device, other processing devices coupled with a wireless modem, an in-vehicle device, a wearable device, a terminal device in a future 5G network, a terminal device in a future evolved public land mobile network (PLMN), etc.

Optionally, the communication system in the embodiment of the present application may be applied to an unlicensed spectrum, where the unlicensed spectrum may also be considered as a shared spectrum; or the communication system in the embodiment of the present application may also be applied to a licensed spectrum, where the licensed spectrum can also be considered an unshared spectrum.

Positioning technology is one of core technologies of wireless communications systems and navigation systems. 5G NR system supports positioning technology. In 3GPP release 16, the following positioning solutions are specified: Downlink (DL) time difference of arrival (TDOA) method, uplink (UL) TDOA method, multi-round trip times (RTT) method, DL angle of departure (AoD) method, UL angle of arrival (AoA) method, and enhanced cell ID (E-CID) method.

In 3GPP NR, downlink positioning reference signal (PRS) is introduced to support downlink positioning measurement and sounding reference signal (SRS) for positioning is introduced to support uplink positioning measurement. Specially, the following measurements for positioning is supported in NR release 16: DL reference signal time difference (RSTD) measured from DL PRS, UL relative time of arrival (RTOA) measured from SRS for positioning, UE receive (Rx)-transmit (Tx) time difference, gNB Rx-Tx time difference, DL PRS reference signal received power (RSRP), UL SRS RSRP, and UL AoA.

The NR based positioning solutions involve the following function entities:

UE: the UE measures DL PRS resources sent from multiple different TRPs or transmits SRS resource for positioning.

Transmission/reception point (TRP): For determining the location of one UE, multiple TRPs are involved generally. Each TRP can transmit DL PRS to the UE or receive and measure SRS for positioning transmitted by the UE.

Location server: it can be referred to as a “location management function” (LMF).

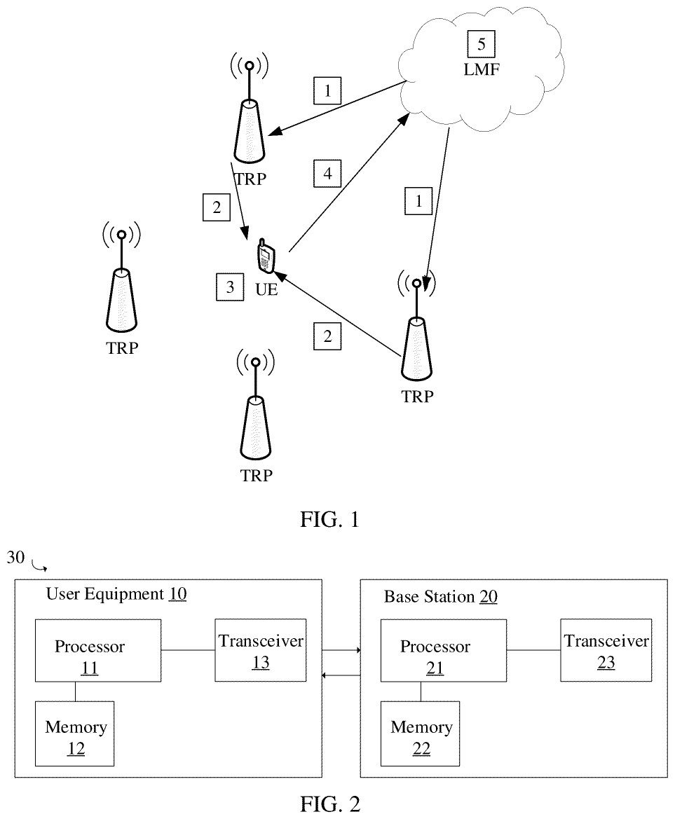

FIG. 1 illustrates an example of NR positioning based on DL measurement. As illustrated in the example, the basic procedure is as follows: The LMF and TRP coordinate DL PRS configurations. Each TRP transmits DL PRS resource according to the DL PRS configurations. The UE measures DL PRS resources transmitted from multiple TRPs and then measures the DL PRS RSRP and/or DL RSTD. The UE reports positioning measurement results to the LMF. Further, the LMF calculates the location of the UE based on the reported positioning measurement results. Specially, in DL-AoD methods, the UE measures the RSRP or path RSRP of one or more DL RS resources and then reports the measurement results to the LMF. The LMF can determine the angle of departure of one UE with respect to each TRP and then the LMF can calculate the location of the UE.

To support uplink positioning method, the UE can transmit SRS resource for positioning. In one UL bandwidth part (BWP) of a UL carrier, the UE can be configured with one or more sets of SRS resources for positioning. In each set, there can be one or more SRS resources for positioning. The UE can transmit one SRS resource for positioning to the serving cell TRP or a non-serving cell TRP. Each SRS resource for positioning can be provided with a pathloss RS, which can be a DL positioning reference signal (PRS) or synchronization signal/physical broadcast channel (SS/PBCH) block of a serving cell or a non-serving cell. The SRS resource for positioning is configured in one UL BWP of a UL carrier. If the UE supports carrier aggregation with multiple UL carriers, the SRS resource for positioning can be configured in multiple UL carriers.

The performance of positioning and the accuracy of timing-based positioning measurement are limited by a bandwidth of the PRS. In current systems, sounding reference signal (SRS) used for positioning is transmitted within each uplink BWP of each uplink carrier. A bandwidth of an SRS for positioning is limited, even when a user equipment (UE) has enough power to transmit the SRS for positioning. Therefore, a performance of uplink timing-based positioning is limited. The UE can transmit multiple SRSs for positioning in multiple uplink carriers, but the current new radio (NR) system and 3rd generation partnership project (3GPP) speciation does enable the NR system to coherently combine SRS for positioning transmitted in different carriers to formulate an equivalent larger bandwidth.

Some embodiments of the present disclosure provides solutions for configuring and transmitting SRS resource for positioning to support the reception of bandwidth aggregation.

FIG. 2 illustrates that, in some embodiments, one or more user equipments (UEs) 10 and a base station (e.g., next generation NodeB (gNB) or eNB) 20 of communication in a communication network system 30 (e.g., an NR system) according to an embodiment of the present disclosure are provided. The communication network system 30 includes the one or more UEs 10 and the base station 20. The one or more UEs 10 may include a memory 12, a transceiver 13, and a processor 11 coupled to the memory 12 and the transceiver 13. The base station 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

In some embodiments, the transceiver 13 is configured by the base station 20 with a first uplink (UL) carrier and a second UL carrier, and the transceiver 13 is indicated by the base station 20 that a first SRS resource in the first UL carrier and a second SRS resource in the second UL carrier are aggregated with bandwidth. This can solve issues in the prior art and other issues, improve a performance of uplink-based positioning, and/or improve a performance of SRS resource allocation.

In some embodiments, the processor 21 is configured to allocate, to the UE 10, a first uplink (UL) carrier and a second UL carrier, and the processor 21 is configured to indicate to the UE 10 that a first SRS resource in the first UL carrier and a second SRS resource in the second UL carrier are aggregated with bandwidth. This can solve issues in the prior art and other issues, improve a performance of uplink-based positioning, and/or improve a performance of SRS resource allocation.

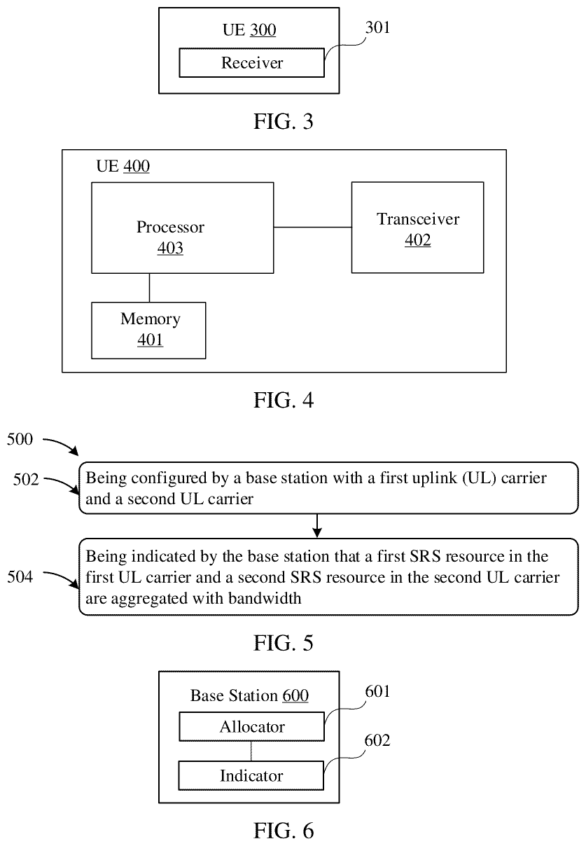

FIG. 3 illustrates an example of a UE 300 according to an embodiment of the present application. The UE 300 is configured to implement some embodiments of the disclosure. Some embodiments of the disclosure may be implemented into the UE 300 using any suitably configured hardware and/or software. The UE 300 includes a receiver 301. The receiver 301 is configured by a base station with a first uplink (UL) carrier and a second UL carrier, and the receiver 301 is indicated by the base station that a first SRS resource in the first UL carrier and a second SRS resource in the second UL carrier are aggregated with bandwidth. This can solve issues in the prior art and other issues, improve a performance of uplink-based positioning, and/or improve a performance of SRS resource allocation.

FIG. 4 illustrates an example of a UE 400 according to an embodiment of the present disclosure. The UE 400 is configured to implement some embodiments of the disclosure. Some embodiments of the disclosure may be implemented into the UE 400 using any suitably configured hardware and/or software. The UE 400 may include a memory 401, a transceiver 402, and a processor 403 coupled to the memory 401 and the transceiver 402. The processor 403 may be configured to implement proposed functions, procedures and/or methods described in this description. Layers of radio interface protocol may be implemented in the processor 403. The memory 401 is operatively coupled with the processor 403 and stores a variety of information to operate the processor 403. The transceiver 402 is operatively coupled with the processor 403, and the transceiver 402 transmits and/or receives a radio signal. The processor 403 may include application-specific integrated circuit (ASIC), other chipset, logic circuit and/or data processing device. The memory 401 may include read-only memory (ROM), random access memory (RAM), flash memory, memory card, storage medium and/or other storage device. The transceiver 402 may include baseband circuitry to process radio frequency signals. When the embodiments are implemented in software, the techniques described herein can be implemented with modules (e.g., procedures, functions, and so on) that perform the functions described herein. The modules can be stored in the memory 401 and executed by the processor 403. The memory 401 can be implemented within the processor 403 or external to the processor 403 in which case those can be communicatively coupled to the processor 403 via various means as is known in the art.

In some embodiments, the transceiver 402 is configured by a base station with a first uplink (UL) carrier and a second UL carrier, and the transceiver 402 is indicated by the base station that a first SRS resource in the first UL carrier and a second SRS resource in the second UL carrier are aggregated with bandwidth. This can solve issues in the prior art and other issues, improve a performance of uplink-based positioning, and/or improve a performance of SRS resource allocation.

FIG. 5 is an example of a method 500 of sounding reference signal (SRS) resource allocation performed by a UE according to an embodiment of the present disclosure. The method 500 of sounding reference signal (SRS) resource allocation performed by a UE is configured to implement some embodiments of the disclosure. Some embodiments of the disclosure may be implemented into the method 500 of sounding reference signal (SRS) resource allocation performed by a UE using any suitably configured hardware and/or software. In some embodiments, the method 500 of sounding reference signal (SRS) resource allocation performed by a UE includes: an operation 502, being configured by a base station with a first uplink (UL) carrier and a second UL carrier, and an operation 504, being indicated by the base station that a first SRS resource in the first UL carrier and a second SRS resource in the second UL carrier are aggregated with bandwidth. This can solve issues in the prior art and other issues, improve a performance of uplink-based positioning, and/or improve a performance of SRS resource allocation.

In some embodiments, the first SRS resource is linked or associated with the second SRS resource for bandwidth aggregation. In some embodiments, the first SRS resource is in a first SRS resource set in the first UL carrier, and the second SRS resource is in a second SRS resource set in the second UL carrier. In some embodiments, the first SRS resource set is linked or associated with the second SRS resource set for bandwidth aggregation. In some embodiments, each SRS resource in the first SRS resource set is linked or associated with each SRS resource in the second SRS resource set for bandwidth aggregation by an ordering of SRS resources. In some embodiments, symbol locations of the first SRS resource and the second SRS resource are same. In some embodiments, the first UL carrier is linked or associated with the second UL carrier for bandwidth aggregation.

In some embodiments, the method further includes being requested to transmit the first SRS resource and the second SRS resource using a same timing advance (TA) value through a signaling. In some embodiments, the signaling includes a downlink control information (DCI) or a medium access control (MAC) control element (CE) activation command. In some embodiments, if the first UL carrier and the second UL carrier are in different timing advance groups (TAGs), the UE is requested to adjust uplink timing for the first SRS resource and the second SRS resource based on a value of timing advance offset associated with a TAG of the first UL carrier or a TAG of the second UL carrier. In some embodiments, the method further includes being requested to calculate a transmit (TX) power of the first SRS resource and a TX power of the second SRS resource to allow the TX power per subcarrier on the first SRS resource and the TX power per subcarrier on the second SRS resource are same.

FIG. 6 illustrates an example of base station 600 according to an embodiment of the present application. The base station 600 is configured to implement some embodiments of the disclosure. Some embodiments of the disclosure may be implemented into the base station 600 using any suitably configured hardware and/or software. The base station 600 includes an allocator 601 and an indicator 602. The allocator 601 is configured to allocate, to a user equipment (UE), a first uplink (UL) carrier and a second UL carrier, and the indicator 602 is configured to indicate to the UE that a first SRS resource in the first UL carrier and a second SRS resource in the second UL carrier are aggregated with bandwidth. This can solve issues in the prior art and other issues, improve a performance of uplink-based positioning, and/or improve a performance of SRS resource allocation.

FIG. 7 illustrates an example of a base station 700 according to an embodiment of the present disclosure. The base station 700 is configured to implement some embodiments of the disclosure. Some embodiments of the disclosure may be implemented into the base station 700 using any suitably configured hardware and/or software. The base station 700 may include a memory 701, a transceiver 702, and a processor 703 coupled to the memory 701 and the transceiver 702. The processor 703 may be configured to implement proposed functions, procedures and/or methods described in this description. Layers of radio interface protocol may be implemented in the processor 703. The memory 701 is operatively coupled with the processor 703 and stores a variety of information to operate the processor 703. The transceiver 702 is operatively coupled with the processor 703, and the transceiver 702 transmits and/or receives a radio signal. The processor 703 may include application-specific integrated circuit (ASIC), other chipset, logic circuit and/or data processing device. The memory 701 may include read-only memory (ROM), random access memory (RAM), flash memory, memory card, storage medium and/or other storage device. The transceiver 702 may include baseband circuitry to process radio frequency signals. When the embodiments are implemented in software, the techniques described herein can be implemented with modules (e.g., procedures, functions, and so on) that perform the functions described herein. The modules can be stored in the memory 701 and executed by the processor 703. The memory 701 can be implemented within the processor 703 or external to the processor 703 in which case those can be communicatively coupled to the processor 703 via various means as is known in the art.

In some embodiments, the processor 703 is configured to allocate, to a user equipment (UE), a first uplink (UL) carrier and a second UL carrier, and the processor is configured to indicate to the UE that a first SRS resource in the first UL carrier and a second SRS resource in the second UL carrier are aggregated with bandwidth. This can solve issues in the prior art and other issues, improve a performance of uplink-based positioning, and/or improve a performance of SRS resource allocation.

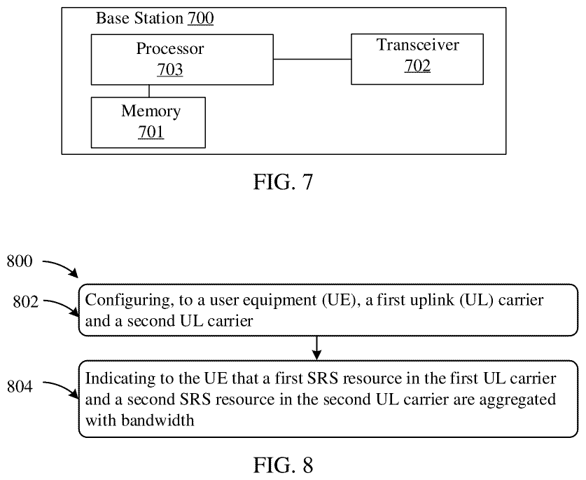

FIG. 8 is an example of a method 800 of sounding reference signal (SRS) resource allocation performed by a base station according to an embodiment of the present disclosure. The method 800 of sounding reference signal (SRS) resource allocation performed by the base station is configured to implement some embodiments of the disclosure. Some embodiments of the disclosure may be implemented into the method 800 of sounding reference signal (SRS) resource allocation performed by the base station using any suitably configured hardware and/or software. In some embodiments, the method 800 of sounding reference signal (SRS) resource allocation performed by the base station includes: an operation 802, configuring, to a user equipment (UE), a first uplink (UL) carrier and a second UL carrier, and an operation 804, indicating to the UE that a first SRS resource in the first UL carrier and a second SRS resource in the second UL carrier are aggregated with bandwidth. This can solve issues in the prior art and other issues, improve a performance of uplink-based positioning, and/or improve a performance of SRS resource allocation.

In some embodiments, the first SRS resource is linked or associated with the second SRS resource for bandwidth aggregation. In some embodiments, the first SRS resource is in a first SRS resource set in the first UL carrier, and the second SRS resource is in a second SRS resource set in the second UL carrier. In some embodiments, the first SRS resource set is linked or associated with the second SRS resource set for bandwidth aggregation. In some embodiments, each SRS resource in the first SRS resource set is linked or associated with each SRS resource in the second SRS resource set for bandwidth aggregation by an ordering of SRS resources. In some embodiments, symbol locations of the first SRS resource and the second SRS resource are same. In some embodiments, the first UL carrier is linked or associated with the second UL carrier for bandwidth aggregation.

In some embodiments, the method further includes requesting the UE to transmit the first SRS resource and the second SRS resource using a same timing advance (TA) value through a signaling. In some embodiments, the signaling includes a downlink control information (DCI) or a medium access control (MAC) control element (CE) activation command. In some embodiments, if the first UL carrier and the second UL carrier are in different timing advance groups (TAGs), the base station requests the UE to adjust uplink timing for the first SRS resource and the second SRS resource based on a value of timing advance offset associated with a TAG of the first UL carrier or a TAG of the second UL carrier. In some embodiments, the method further includes requesting the UE to calculate a transmit (TX) power of the first SRS resource and a TX power of the second SRS resource to allow the TX power per subcarrier on the first SRS resource and the TX power per subcarrier on the second SRS resource are same.

### Exemplary Technical Solutions

In some embodiments, a UE can be configured with more than one UL carrier. In a first UL carrier, the UE can be configured with one or more SRS resources for positioning. In a second UL carrier, the UE can be configured with one or more SRS resources for positioning. The UE can be indicated by a system that a first SRS resource for positioning in the first UL carrier and a second SRS resource for positioning in the second UL carrier can be aggregated with bandwidth for positioning measurement at the receiver side.

For example, the system can indicate to the UE that the first SRS resource and the second SRS resource are linked or associated with each other for bandwidth aggregation. With the configuration provided by the system, the UE can be requested to transmit the first SRS resource and the second SRS resource accordingly. For example, the UE can be requested to apply one same timing advance (TA) value on the transmission of the first SRS resource and the second SRS resource, even through they are transmitted on different UL carriers. The system can use a single DCI to trigger the transmission of the first SRS resource for positioning and the second SRS resource for positioning. If the SRS resource for positioning is semi-persistent, the system can use a single medium access control (MAC) control element (CE) activation command to activate the transmission.

In some embodiments, a UE can be configured with a first SRS resource set for positioning in a first uplink carrier and the UE can be configured with a second SRS resource set for positioning in a second uplink carrier. The first set of SRS resources for positioning can contain one or more SRS resources for positioning and the second set of SRS resources for positioning can contain one or more SRS resources for positioning. The UE can be indicated by the system that one SRS resource in the first set is linked or associated with one SRS resource in the second set for reception with bandwidth aggregation. The present disclosure provides various embodiments for providing the configuration of linking SRS resources for bandwidth aggregation.

For instance, the UE can be provided with configuration information that indicates the first SRS resource set for positioning is linked or associated with the second SRS resource set for positioning.

For example, the configuration of one SRS resource set for positioning can contain one indicator, and sets of SRS resource for positioning with the indicator setting to the same value are linked or associated with each other for reception of bandwidth aggregation. For example, the configuration of the first SRS resource set for positioning has the indicator set to 0 and the configuration of the second SRS resource set for positioning has the indicator set to 1. Then the SRS resource in the first SRS resource set is linked or associated with the SRS resource in the second SRS resource set for the reception of bandwidth aggregation.

When the UE receives an indication that the first SRS resource set for positioning is linked or associated with the second SRS resource set for positioning for the reception with bandwidth aggregation, the UE can assume that each SRS resource in the first SRS resource set is linked or associated with each SRS resource in the second SRS resource set for the reception of bandwidth aggregation by the ordering of SRS resource in each set.

When the UE receives an indication that the first SRS resource set for positioning is linked or associated with the second SRS resource set for positioning for the reception with bandwidth aggregation, the UE can assume one SRS resource in the first SRS resource set is linked or associated with one SRS resource in the second SRS resource set if the symbol locations of these two SRS resources are the same.

In some embodiments, the UE can receive an indication that the first uplink carrier and the second uplink carrier are linked or associated with each other for the reception of bandwidth aggregation. For example, each uplink carrier can be configured with an indicator that is used to indicate the linking or association for reception of bandwidth aggregation for positioning measurement. If the indicator of the first uplink carrier and the indicator of the second uplink carrier are set to the same value, the UE can assume that the first uplink carrier and the second uplink carrier are linked or associated with each other for the reception of bandwidth aggregation for positioning measurement.

For example, a first uplink carrier can be provided with an index of a second uplink carrier, that is used to indicate that the first uplink carrier is linked or associated with the second uplink carrier for the reception of bandwidth aggregation for positioning measurement.

If the UE receives an indication that the first uplink carrier and the second uplink carrier are linked or associated with each other, the UE can assume that the SRS resource for positioning configured in the first uplink carrier is linked or associated with the SRS resource for positioning configured in the second uplink carrier for the reception of bandwidth aggregation. The UE can assume that each SRS resource set for positioning configured in the fire const uplink carrier is linked or associated with each SRS resource set for positioning configured in the second uplink carrier by the ordering of SRS resource set for positioning in each uplink carrier.

In some embodiments, the UE can receive an indication that a first SRS resource for positioning is linked or associated with a second SRS resource for positioning for the reception of bandwidth aggregation for positioning measurement. For example, the configuration of each SRS resource for positioning can include an indicator that indicate the association between SRS resources for positioning for the reception of bandwidth aggregation. If a SRS resource for positioning in the first uplink carrier and a SRS resource for positioning in the second uplink carrier are configured with the same value to the indicator, the UE can assume these two SRS resources for positioning are linked or associated with each other for reception of bandwidth aggregation.

For example, the configuration of one SRS resource for positioning can contain ID(s) of one or more SRS resources for positioning configured in other uplink carriers and the SRS resource for positioning is linked or associated with the SRS resource(s) for positioning that are indicated by the IDs contained in the configuration of the SRS resource for positioning.

In some embodiments, the UE may receive a request to transmit two linked SRS resources for positioning with a same TA value. The UE can be configured with SRS resource for positioning on a first uplink carrier and the UE can be configured with SRS resource for positioning on a second uplink carrier. The UE can be configured so that a first SRS resource for positioning on the first uplink carrier and a second SRS resource for positioning on the second uplink carrier are linked for the reception of bandwidth aggregation. The UE may receive a request to apply the same TA on the transmission of the first SRS resource for positioning and the second SRS resource for positioning. If the first uplink carrier and the second uplink carrier are in different timing advance groups (TAGs), the UE may receive a request to adjust the uplink timing for the first SRS resource for positioning and the second SRS resource for positioning based on a value of timing advance offset associated with the TAG of the first uplink carrier. If the first uplink carrier and the second uplink carrier are in different TAGs, the UE may be requested to adjust the uplink timing for the first SRS resource for positioning and the second SRS resource for positioning based on a value of timing advance offset associated with the TAG of the second uplink carrier.

In some embodiments, the UE can be configured with a semi-persistent SRS resource for positioning on a first uplink carrier and the UE can be configured with semi-persistent SRS resource for positioning on a second uplink carrier. The UE can be configured with that a first SRS resource for positioning with semi-persistent SRS resources on the first uplink carrier and a second SRS resource with semi-persistent SRS resources for positioning on the second uplink carrier are linked or associated with each other for the reception of bandwidth aggregation. The system can send one MAC CE activation to activate the transmission of both the first SRS resource set and the second SRS resource set.

In some embodiments, the system sends one MAC CE activation command and the ID of the first SRS resource set is indicated in the MAC CE activation command. Upon receiving the MAC CE activation command, the UE may be requested to transmit the SRS resources contained in the first SRS resource set and also the SRS resources contained in the second SRS resource set. In the MAC CE command, the UE can be indicated with spatial-relation information or a transmission configuration indicator (TCI) state for each SRS resource contained in the first SRS resource set. With that, the UE may receive a request to apply the indicated spatial-relation information or TCI state on the corresponding SRS resource in the first SRS resource set and also on the linked SRS resource in the second SRS resource set.

In some embodiments, the UE can be configured with an aperiodic SRS resource for positioning on a first uplink carrier and an aperiodic SRS resource for positioning on a second uplink carrier. The UE can be configured with that a first SRS resource for positioning with aperiodic SRS resources on the first uplink carrier and a second SRS resource with aperiodic SRS resources for positioning on the second uplink carrier are linked or associated with each other for the reception of bandwidth aggregation. The system can send one DCI format to trigger the transmission of both the first SRS resource set and the second SRS resource set. In one example, the system sends one DCI command and the ID of the first SRS resource set is indicated in the DCI command. Upon receiving the DCI command, the UE can be requested to transmit the SRS resources contained in the first SRS resource set and also the SRS resources contained in the second SRS resource set.

In some embodiments, the UE can be configured with an SRS resource for positioning on a first uplink carrier and an SRS resource for positioning on a second uplink carrier. The UE can be configured so that a first SRS resource set for positioning on the first uplink carrier and a second SRS resource set for positioning on the second uplink carrier are linked or associated with each other for the reception of bandwidth aggregation. The UE can be indicated that a first SRS resource for positioning in the first uplink carrier and a second SRS resource for positioning in the second uplink carrier are linked or associated with each other for the reception of bandwidth aggregation. When the UE transmits the first SRS resource for positioning and the second SRS resource for positioning, the UE may be requested to calculate the transmit (Tx) power of the first SRS resource and the second SRS resource so that Tx power per subcarrier on the first SRS resource and the Tx power per subcarrier on the second SRS resource are same. When the total UE transmit power for a physical uplink shared channel (PUSCH), a physical uplink control channel (PUCCH), a physical random access channel (PRACH) and the SRS on serving cells exceeds the maximum power control (PCMAX), the UE may receive a request to calculate the Tx power of the first SRS resource and the second SRS resource so that Tx power per subcarrier on the first SRS resource and the Tx power per subcarrier on the second SRS resource are same.

Technical Benefits: In some embodiments, using the proposed technique(s), the 5G NR system may support new transmission mechanisms of SRS for positioning, which can support the positioning system to coherently combine multiple SRS resources for positionings that are transmitted in different uplink carriers. This may boost the system's performance for uplink timing-based positioning measurement, thereby improving the performance of uplink-based positioning method and improve the whole NR positioning system.

Commercial interests for some embodiments are as follows. 1. Solve issues in the prior art and other issues. 2. Improve a performance of uplink-based positioning. 3. Improve a performance of SRS resource allocation. 4. Provide a good communication performance. 5. Provide high reliability. Some embodiments of the present disclosure can be used in many applications. Some embodiments of the present disclosure are used by chipset vendors, video system development vendors, automakers including cars, trains, trucks, buses, bicycles, moto-bikes, helmets, and etc., drones (unmanned aerial vehicles), smartphone makers, communication devices for public safety use, AR/VR/MR device maker for example gaming, conference/seminar, education purposes. Some embodiments of the present disclosure are a combination of “techniques/processes” that can be adopted in video standards to create an end product. Some embodiments of the present disclosure propose technical mechanisms. The at least one proposed solution, method, system, and apparatus of some embodiments of the present disclosure may be used for current and/or new/future standards regarding communication systems such as a UE, a base station, and/or a communication system. Compatible products follow at least one proposed solution, method, system, and apparatus of some embodiments of the present disclosure. The proposed solution, method, system, and apparatus are widely used in a UE, a base station, and/or a communication system. With the implementation of the at least one proposed solution, method, system, and apparatus of some embodiments of the present disclosure, at least one modification to methods and apparatus of sounding reference signal (SRS) resource allocation are considered for standardizing.

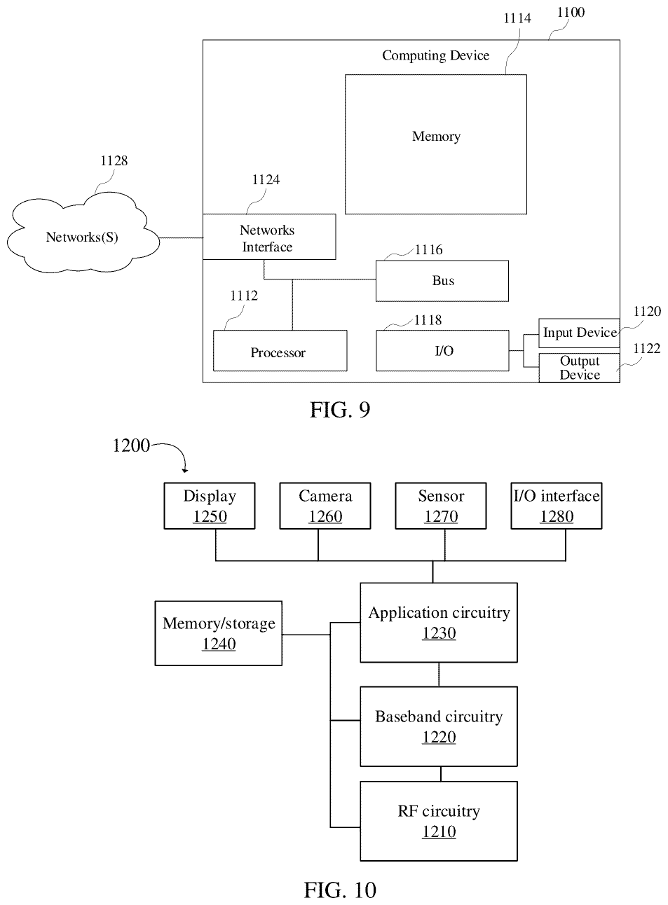

FIG. 9 is an example of a computing device 1100 according to an embodiment of the present disclosure. Any suitable computing device can be used for performing the operations described herein. For example, FIG. 9 illustrates an example of the computing device 1100 that can implement some embodiments of FIG. 1 to FIG. 8 using any suitably configured hardware and/or software. In some embodiments, the computing device 1100 can include a processor 1112 that is communicatively coupled to a memory 1114 and that executes computer-executable program code and/or accesses information stored in the memory 1114. The processor 1112 may include a microprocessor, an application-specific integrated circuit (“ASIC”), a state machine, or other processing device. The processor 1112 can include any of a number of processing devices, including one. Such a processor can include or may be in communication with a computer-readable medium storing instructions that, when executed by the processor 1112, cause the processor to perform the operations described herein.

The memory 1114 can include any suitable non-transitory computer-readable medium.

The computer-readable medium can include any electronic, optical, magnetic, or other storage device capable of providing a processor with computer-readable instructions or other program code. Non-limiting examples of a computer-readable medium include a magnetic disk, a memory chip, a read-only memory (ROM), a random access memory (RAM), an application specific integrated circuit (ASIC), a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C#, visual basic, java, python, perl, javascript, and actionscript.

The computing device 1100 can also include a bus 1116. The bus 1116 can communicatively couple one or more components of the computing device 1100. The computing device 1100 can also include a number of external or internal devices such as input or output devices. For example, the computing device 1100 is illustrated with an input/output (“I/O”) interface 1118 that can receive input from one or more input devices 1120 or provide output to one or more output devices 1122. The one or more input devices 1120 and one or more output devices 1122 can be communicatively coupled to the I/O interface 1118. The communicative coupling can be implemented via any suitable manner (e.g., a connection via a printed circuit board, connection via a cable, communication via wireless transmissions, etc.). Non-limiting examples of input devices 1120 include a touch screen (e.g., one or more cameras for imaging a touch area or pressure sensors for detecting pressure changes caused by a touch), a mouse, a keyboard, or any other device that can be used to generate input events in response to physical actions by a user of a computing device. Non-limiting examples of output devices 1122 include a liquid crystal display (LCD) screen, an external monitor, a speaker, or any other device that can be used to display or otherwise present outputs generated by a computing device.

The computing device 1100 can execute program code that configures the processor 1112 to perform one or more of the operations described above with respect to some embodiments of FIG. 1 to FIG. 8. The program code may be resident in the memory 1114 or any suitable computer-readable medium and may be executed by the processor 1112 or any other suitable processor.

The computing device 1100 can also include at least one network interface device 1124. The network interface device 1124 can include any device or group of devices suitable for establishing a wired or wireless data connection to one or more data networks 1128. Non limiting examples of the network interface device 1124 include an Ethernet network adapter, a modem, and/or the like. The computing device 1100 can transmit messages as electronic or optical signals via the network interface device 1124.

FIG. 10 is a block diagram of an example of a communication system 1200 according to an embodiment of the present disclosure. Embodiments described herein may be implemented into the communication system 1200 using any suitably configured hardware and/or software. FIG. 10 illustrates the communication system 1200 including a radio frequency (RF) circuitry 1210, a baseband circuitry 1220, an application circuitry 1230, a memory/storage 1240, a display 1250, a camera 1260, a sensor 1270, and an input/output (I/O) interface 1280, coupled with each other at least as illustrated.

The application circuitry 1230 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system. The communication system 1200 can execute program code that configures the application circuitry 1230 to perform one or more of the operations described above with respect to some embodiments of FIG. 1 to FIG. 8. The program code may be resident in the application circuitry 1230 or any suitable computer-readable medium and may be executed by the application circuitry 1230 or any other suitable processor.

The baseband circuitry 1220 may include circuitry such as, but not limited to, one or more single-core or multi-core processors. The processors may include a baseband processor. The baseband circuitry may handle various radio control functions that may enable communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 1220 may include circuitry to operate with signals that are not strictly considered as being in a baseband frequency. For example, in some embodiments, baseband circuitry may include circuitry to operate with signals having an intermediate frequency, which is between a baseband frequency and a radio frequency. The RF circuitry 1210 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 1210 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to some embodiments of FIG. 1 to FIG. 8 may be embodied in whole or in part in one or more of the RF circuitry, the baseband circuitry, and/or the application circuitry. As used herein, “circuitry” may refer to, be part of, or include an application specific integrated circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the application circuitry, and/or the memory/storage may be implemented together on a system on a chip (SOC). The memory/storage 1240 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 1280 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface. In various embodiments, the sensor 1270 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 1250 may include a display, such as a liquid crystal display and a touch screen display. In various embodiments, the communication system 1200 may be a mobile computing device such as, but not limited to, a laptop computing device, a tablet computing device, a netbook, an ultrabook, a smartphone, an AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A method of sounding reference signal (SRS) resource allocation, by a user equipment (UE), comprising:
being configured by a base station with a first uplink (UL) carrier and a second UL carrier; and
being indicated by the base station that a first SRS resource in the first UL carrier and a second SRS resource in the second UL carrier are aggregated with bandwidth.

2. The method of claim 1, wherein the first SRS resource is linked or associated with the second SRS resource for bandwidth aggregation.

3. The method of claim 2, wherein the first SRS resource is in a first SRS resource set in the first UL carrier, and the second SRS resource is in a second SRS resource set in the second UL carrier.

4. The method of claim 3, wherein the first SRS resource set is linked or associated with the second SRS resource set for bandwidth aggregation.

5. The method of claim 1, wherein symbol locations of the first SRS resource and the second SRS resource are same.

6. The method of claim 1, further comprising being requested to transmit the first SRS resource and the second SRS resource using a same timing advance (TA) value through a signaling, wherein the signaling comprises a downlink control information (DCI) or a medium access control (MAC) control element (CE) activation command.

7. The method of claim 6, further comprising being requested to calculate a transmit (TX) power of the first SRS resource and a TX power of the second SRS resource to allow the TX power per subcarrier on the first SRS resource and the TX power per subcarrier on the second SRS resource are same.

8. A method of sounding reference signal (SRS) resource allocation, by a base station, comprising: configuring, to a user equipment (UE), a first uplink (UL) carrier and a second UL carrier; and indicating to the UE that a first SRS resource in the first UL carrier and a second SRS resource in the second UL carrier are aggregated with bandwidth.

9. The method of claim 8, wherein the first SRS resource is linked or associated with the second SRS resource for bandwidth aggregation.

10. The method of claim 9, wherein the first SRS resource is in a first SRS resource set in the first UL carrier, and the second SRS resource is in a second SRS resource set in the second UL carrier.

11. The method of claim 10, wherein the first SRS resource set is linked or associated with the second SRS resource set for bandwidth aggregation.

12. The method of claim 8, wherein symbol locations of the first SRS resource and the second SRS resource are same.

13. The method of claim 8, further comprising requesting the UE to transmit the first SRS resource and the second SRS resource using a same timing advance (TA) value through a signaling, wherein the signaling comprises a downlink control information (DCI) or a medium access control (MAC) control element (CE) activation command.

14. A user equipment (UE), comprising:
a memory;
a transceiver; and
a processor coupled to the memory and the transceiver;
wherein the UE is configured to:
be configured by a base station with a first uplink (UL) carrier and a second UL carrier; and
be indicated by the base station that a first SRS resource in the first UL carrier and a second SRS resource in the second UL carrier are aggregated with bandwidth.

15. The UE of claim 14, wherein the first SRS resource is linked or associated with the second SRS resource for bandwidth aggregation.

16. The UE of claim 15, wherein the first SRS resource is in a first SRS resource set in the first UL carrier, and the second SRS resource is in a second SRS resource set in the second UL carrier.

17. The UE of claim 16, wherein the first SRS resource set is linked or associated with the second SRS resource set for bandwidth aggregation.

18. The UE of claim 14, wherein symbol locations of the first SRS resource and the second SRS resource are same.

19. The UE of claim 14, wherein the UE is further configured to: be requested to transmit the first SRS resource and the second SRS resource using a same timing advance (TA) value through a signaling, wherein the signaling comprises a downlink control information (DCI) or a medium access control (MAC) control element (CE) activation command.

20. The UE of claim 19, wherein the UE is further configured to: be requested to calculate a transmit (TX) power of the first SRS resource and a TX power of the second SRS resource to allow the TX power per subcarrier on the first SRS resource and the TX power per subcarrier on the second SRS resource are same.
